(19) United States
(12) Patent Application Publication
(10) Pub. No.: US 2001/0042024 A1
(43) Pub. Date: Nov. 15, 2001

(54) System to provide web-based sales involving storage facilities

(76) Inventor: Theodore Gordon Rogers, Clinton, MT (US)

Correspondence Address: John K. McDonald Ph.D., KILPATRICK STOCKTON LLP, 2400 Monarch Tower, 3424 Peachtree Road, N.E., Atlanta, GA, 30326, US

(21) Appl. No.: 09/782,832

(22) Filed: Feb. 14, 2001

Related U.S. Application Data
(60) Provisional application No. 60/182,671, filed on Feb. 15, 2000.

(51) Int. Cl. G06F 17/60

(52) U.S. Cl. 705/26; 705/8

(57) ABSTRACT

The present invention comprises a method for a user purchasing goods from a merchant, and a merchant delivering goods to a user. After communicating with a server system through a merchant website, the user selects one or more goods to purchase and the user places an order for selected goods via a user terminal. Then, the order is communicated to the assembling means via a merchant interface unit, prompting the assembling means to take the products from the merchant's inventory and assemble the order. A storage devices for a time slot chosen by the user is allocated via a reservation system and method, and given a combination which will open the storage unit during the chosen time slot. The order is placed by the assembling means in the storage unit for the user to pick up. The storage units are monitored to determine if the user picked up the goods at the chosen time slot. The storage units may also be used for sending packages and receiving packages sent to the user. Besides accessing the merchant through the merchant website, the user may also purchase the goods through a kiosk, i.e., located outside the merchant's facility.

### PRIOR RELATED APPLICATIONS

This application claims priority to U.S. provisional patent application Ser. No. 60/182,671 filed on Feb. 15, 2000.

### FIELD OF THE INVENTION

The present invention relates to the field of electronic commerce, and in particular, the software to provide a web-based store which utilizes external storage facilities accessible by the customer.

### BACKGROUND OF THE INVENTION

For many years a trip to the store required leaving the comfort of your home, traveling to a store, browsing the merchandise, selecting the desired merchandise fighting the crowds of other shoppers, waiting in line to pay for the merchandise, and traveling to the next store or eventually home.

This method of purchasing and obtaining desired merchandise is not only inconvenient but has many disadvantages. This method involves excessive travel in urban, suburban and rural areas. Excessive travel in any locale involves wasteful expenditure of energy and contributes to the pollution of the environment from burning fossil fuel, depletion of the ozone layer, and increased release of hydrocarbons, lead and sulfuric acid into the atmosphere. Further, the fuel reserves of earth are limited and increasingly expensive to purchase. Traffic congestion in urban and suburban areas often make shopping a nightmare of wasted time, traffic jams and frayed nerves.

Shopping in rural areas often necessitates numerous trips to widely separated stores, requiring large amounts of time and fuel. Increased vehicular usage also produces more wear on a vehicle, increasing maintenance costs and eventually accelerating replacement costs. A farmer traveling to one or more towns to purchase groceries, feed for livestock, veterinary supplies, prescription drugs, and recreational materials such as compact discs or videos may spend an entire day on the road, particularly in inclement weather.

Use of public transportation for shopping not only increases pollution and wasted energy but also is extremely inconvenient for the shopper, necessitating several changes of busses or trains, while carrying bags of purchased items.

Conventional modes of shopping can also be dangerous in urban areas and increasingly in suburban areas, particularly at shopping malls. In urban areas, many residents, particularly the elderly, fear for their lives when venturing to the local store. Criminals in urban areas often wait for victims near stores, knowing that the victims have cash or other merchandise. Furthermore, merchants are at heightened risk in many urban neighborhoods, and the news is replete with incidents of larceny, armed robbery and murder. In suburban shopping malls, shoppers are often assaulted and sometimes beaten or robbed at gunpoint by thieves who stalk their victims in large parking lots. Many shopping malls now employ small armies of security personnel who travel through mall parking lots in vehicles. Stores extensively employ security guards, install surveillance equipment and spend large sums of money trying to prevent and monitor ongoing theft. All these costs are eventually passed on to the consumer in the form of higher prices for the merchandise.

Some merchandise, such as groceries, meats and dairy products, have limited shelf life and require special storage conditions to maintain freshness and prevent bacterial growth. Excessive travel for shopping in congested urban areas and in rural areas, and traffic jams in the suburbs, increases the time that perishable goods are exposed to unfavorable conditions, thereby accelerating their spoilage and potential for food poisoning.

Some items, such as wine stored in corked bottles, require special conditions of humidity to prevent corks from drying and cracking, or from becoming excessively moist. Vegetables and flowers also have special humidity needs. What is needed is a system that decreases exposure of merchandise to unfavorable storage conditions, and maintains desired temperature and humidity.

Many families in modem society have two working individuals who are parents or partners. When both individuals work, the pressure to finish all shopping chores as soon as possible dramatically increases. This is particularly true when children are waiting at home or must be picked up from day care or school and transported to an activity, such as a sporting event, a music lesson or a scout meeting. The net result of the inefficient and inconvenient current methods of shopping is that pressure increases on working individuals who are exhausted at the end of the day, leaving little or no energy for pursuit of other interests or interacting with spouses, partners or children. Accordingly, convenience and efficiency are paramount in today's society.

Currently, some merchant websites offer home delivery of goods purchased on a store website, such as “kozmo.com”. However, these websites do not offer a storage option where the goods can be picked up by the customer at a particular time. Further, home delivery services in general require the consumer to be home when the delivery is made which is inconvenient for many consumers.

What is needed is a convenient system that provides a consumer with the ability to do “one stop” shopping and to pick up the desired merchandise at a selected time and location.

What is needed is a system that increases the convenience of shopping.

What is also needed is a system that decreases excessive travel associated with shopping, thereby saving time and energy.

What is further needed is a shopping system that decreases spoilage of perishable goods due to enhanced control of temperature and humidity conditions in storage units.

What is also needed is a shopping system that eliminates the need for using cash while shopping.

What is also needed is a shopping system that provides storage units for desired merchandise, wherein the storage units provide conditions favorable for increasing the shelf life of the merchandise.

What is needed is a system that that not only provides storage units for desired merchandise to be delivered by vendors and picked up during reserved time intervals but also permits the user to send packages.

Also needed is a shopping system that provides storage units that may be accessed by one or more merchants so that the merchandise selected by the consumer may be placed in the storage unit for pick up at a selected time.

What is also needed is a shopping system that provides storage units that may be accessed by the consumer during a reserved time interval using a security code to gain access to the storage unit.

### SUMMARY OF THE INVENTION

The present invention solves problems inherent in prior methods of shopping. The present invention eliminates the headache of traveling to a store, obtaining a parking space, entering the store, selecting the merchandise, waiting in line to pay, finding the car, traveling to the next store or to several stores, repeating the process, and eventually going home. This invention permits individuals to shop from the comfort of their own home or office or other location, any time of day or night.

Widespread internet access is making life easier for millions. The present invention provides a system and a method for shopping over the internet and obtaining the selected items at a location during a reserved time interval. Through the use of the present invention, the consumer may obtain selected merchandise without the necessity of entering a store. With this invention, the internet accommodates purchases whereby the customer can use communication means to link to the internet and access web sites of stores, select and order desired merchandise, pay for the merchandise without using cash, select a location containing a storage device for receiving the purchased merchandise, select a time interval for obtaining the purchased merchandise wherein the merchandise will be placed in the storage device by others, access the storage unit within the storage device during the reserved time interval using an access code, remove the merchandise, close the door and leave.

Specific storage devices, and units within the storage device, are assigned by a server system which maintains an inventory of the storage devices, the available storage units within the devices, and the time intervals during which these storage units are available for assignment to a consumer for pick up of merchandise, and the time intervals during which the these storage units are available for assembling means, such as pickers, to load merchandise into the unit before the customer arrives. The server receives the customer's request for a specific storage device at a desired location and receives the customer's request for access to the storage unit during a specific time interval, compares these requests to the available inventory of storage units, determines if a match is available, and if so, assigns to the customer a unit or locker within the storage device to be available for a specified time interval. If no units are available at the requested storage device location during the desired time interval, the server then interrogates the inventory to determine the closest match to the request. After obtaining either the precise match, or the closest match to the customer's request, the server informs the customer of this information through communication means, and may assign an access code. If the customer determines that the time interval and location are acceptable, the customer uses the communication means to inform the server and then the customer receives an access code for obtaining access to the assigned storage unit during the assigned time interval. The assigned location and time interval are also communicated to the store and/or to personnel hired to pick the desired merchandise and place it within the assigned unit during the interval, or in an interval preceding the time interval assigned to the customer. In this manner, the merchandise is available to the customer in the assigned storage unit during the interval assigned to the customer.

It is to be understood that storage devices may be located wherever desired. Non-limiting examples of the locations of storage devices include the following: retail stores; wholesale stores; shopping malls; strip malls; warehouses; office buildings; apartment buildings; condominiums; airports; train stations; subways; bus stations; restaurants; commissaries; military bases; educational institutions; dormitories; entertainment facilities; museums; athletic facilities; and, shipping ports. In one embodiment a storage device is located in a wall of a retail store. In another embodiment a storage device is located in a wall of a warehouse. In yet another embodiment a storage device is free standing and is not located in a wall of an existing structure. These independent or free standing storage units may be located anywhere.

An storage unit within a suitable storage device may be heated, cooled, and/or humidified, in order to provide adequate storage for perishable goods. The units may be equipped with a variety of detectors to determine, for example, when access occurs, if merchandise is present in the storage unit, if temperature and humidity are maintained within desired ranges, to signal tampering or theft, and to determine when the door to the unit is open or closed. The storage unit may also be equipped with communication means, operably connected to the detectors, for transmitting information to another location, such as to the server, to the police station or to the fire department. Communication means may also be used by a consumer to send a message indicating, for example, that an error had been made by a picker in selecting an item, or that an item in the storage unit was defective. In this manner, the consumer may receive a credit for the cost of the item and a replacement may be ordered. An individual storage unit may also contain communication means for the customer to access the internet. In this manner, a customer may use a storage unit-based device suitable for accessing the internet, such as a keypad, touch screen or other suitable device providing a portal to the internet, gain access to a store's inventory, place an order, pay for the order, and reserve a storage unit and time interval for subsequent pick-up of the goods.

In another embodiment, this system also contains the capability for the consumer to send packages through the storage unit and into a storage bin so that a pick up service may obtain from the storage bin all packages sent from users of the storage device. This embodiment permits coordinated delivery and pickup by vendors offering these services. This capability may be built into any of the embodiments of the present invention. Such capability is particularly desirable in storage devices located in or near office buildings, apartment buildings, condominiums and retail stores.

Customers may pay for goods without using cash. Payment may be made through any convenient means, such as through electronic means, including but not limited to use of credit account information, debit account information, or gift certificate credit information. Such information may be communicated through any convenient means, including but not limited to, scanning of codes on cards, such as bar codes, magnetic strip readers, manually inputting credit or debit card account numbers through a touch screen keyboard, voice recognition system or other means. It is to be understood that other means of credit verification are included within the scope of the present invention. For example, when account information from debit or credit cards is unnecessary, a fingerprint, retinal scan or voice print recognition system known to one of ordinary skill in the art may suffice for identification of the individual and then for verification of the credit status of the individual.

This system will accommodate individuals with busy schedules who have internet access and do not want to travel to one or more stores. The present system provides an efficient manner to execute internet-based sales by providing reserved time slots for consumers to access the storage lockers and maximize the turnover of the storage lockers.

This invention comprises a method and system which allows a store to accommodate sales originating from a website. The invention also includes a reservation system and method which schedules the storage devices involved in the sales for different time slots. According to the invention, the customer first accesses the internet through a portal suitable for such access. Such portals include, but are not limited to wired and wireless communication means, including phones, cell phones, computer terminals, entertainment centers, in keypads, pagers, card readers, and touch screens. These portals may be located at any desirable location, including but not limited to, the office, home, car, in airplanes, within a storage unit contained in a storage device, in a kiosk, at a store, and outside or inside a shopping mall.

Other portals may be located at the store and perhaps within the storage units associated with the store, and may not require internet access. In this embodiment, a customer may browse through a store's inventory, select the desired merchandise, pay for the merchandise, select a storage unit at the store and a time interval for subsequent pick up of the merchandise, return during the time interval, open the unit and remove the merchandise. In another embodiment, the customer may simply wait for the pickers at the store, for example a convenience store, to pick the desired items from the store's inventory and place them within the unit for the customer to access and remove.

After obtaining access to the internet, the customer accesses the store website, makes purchases, and pays for the goods. At the time the purchase is made, the storage device scheduler within the server determines which time interval the customer wants the goods in the storage unit for customer pick up. Furthermore, a combination is generated which will open the storage unit at the appropriate time interval. After purchase, an assembling means acquires the selected goods purchased by the customer, and places these items in the designated storage unit at the reserved time interval. The customer arrives at the storage unit during the reserved time interval and uses the combination to open the door to the storage unit. The customer removes the merchandise and the door closes.

A monitoring means detects that the storage device is empty and available for scheduling by the server for the next customer to reserve the unit. If the unit had already been reserved for the next time interval, the assembling means, for example pickers of the merchandise, may already be at the unit, ready to place the next set of ordered merchandise inside the unit. If the customer obtains the merchandise before the end of the reserved time interval, the monitoring means communicates that fact to the server which then prompts the assembling means that the unit is available for stocking with the next order. The server also sends a message to a second customer picking up this next order in this unit that the order may be picked up at an earlier time. This message may be sent through any wired or wireless communication means desired by the customer, including but not limited to the following: cell phone, e mail, facsimile, pager, wired phone, or voice messaging system. If the customer chooses to pick up the merchandise earlier than the end of the time interval previously assigned to that customer, then the customer may send that message to the server through the communication means. The server may then indicate to the assembling means and to the third customer assigned to that unit that an earlier loading of the merchandise and an earlier third pick up may be scheduled. In this manner, the units are utilized more efficiently, customers may adjust their schedules accordingly, and obtain desired merchandise in a more convenient and efficient manner. In addition, the units may supply more customers by using current unit availability information to maximize use of the unit.

Accordingly it is an object of the present invention to provide a system and method for ordering merchandise and selecting a time interval through a reservation system for obtaining the desired merchandise from a storage unit at a desired location.

It is another object of the present invention to provide a web-based system and method for ordering merchandise and selecting a time interval through a reservation system for obtaining the desired merchandise, wherein ordering of the merchandise is accomplished through the internet.

Yet another object of the present invention is to provide a web-based system and method for ordering merchandise and selecting a location and a time interval through a reservation system for obtaining the desired merchandise, wherein ordering of the merchandise is accomplished through the internet and the merchandise is sold through a retail vendor.

Yet another object of the present invention is to provide a web-based system and method for ordering merchandise and selecting a location and a time interval through a reservation system for obtaining the desired merchandise from a storage unit previously loaded with the merchandise, wherein ordering of the merchandise is accomplished through the internet and the merchandise is sold through a warehouse.

Another object of the present invention is to provide a web-based system and method to order merchandise from more than one vendor, select a time interval through a reservation system for obtaining the desired merchandise from a storage unit, have pickers obtain the ordered merchandise from the vendors' stores, place the merchandise in the storage unit, and grant access to the customer for access the storage unit to obtain the merchandise.

Yet another object of the present invention is to provide a web based system and method to order merchandise, wherein the storage unit is located in the wall of a retail store.

Still another object of the present invention is to provide a web based system and method to order merchandise, wherein the storage unit is located in the wall of a warehouse.

Yet another object of the present invention is to provide a web based system and method to order merchandise, wherein the storage unit is a stand alone unit placed in a selected location.

Some advantages of the present invention are that it provides a more efficient way to purchase goods, it is more convenient for the consumer, decreases lost time, decreases unnecessary travel, saves fuel and contributes to a cleaner environment.

Another advantage of the present invention is that shoppers may place orders and pick up merchandise at their convenience, even during hours when stores are closed.

Additional advantages of the present invention are that it provides a safer method of shopping, decreases delivery costs, decreases labor costs for retail stores and decreases the cost of goods.

These and other objects, features and advantages of the present invention will become apparent after a review of the following detailed description of the disclosed embodiments.

### BRIEF DESCRIPTION OF THE DRAWINGS

FIG. 1 is a simplified diagram of the business transaction resulting from the software and system of the present invention.

FIG. 2 is simplified diagram of the system of the present invention, with its several components.

FIG. 3 is a flow chart diagram illustrating how goods are purchased by a user from a merchant using the method of the present invention.

FIG. 4 is a flow diagram illustrating how the storage device scheduler handles reservations of storage devices.

FIG. 5 is a flow diagram illustrating the storage device scheduler at the conclusion of the time slot.

FIG. 6 is a schematic representation of an automatic distribution system (ADS) installed in the wall of a grocery store.

FIG. 7 is a schematic representation of a free-standing independent distribution system (IDS) located in the country.

FIG. 8 is a schematic representation of an warehouse distribution system (WDS) installed in a wall of a warehouse.

FIG. 9 is a schematic representation of an temperature-controlled automatic distribution system (ADS) installed in the wall of a convenience store or grocery store.

FIG. 10 is a schematic representation of the assembly that may be added to individual storage units for sending packages and other items.

### DETAILED DESCRIPTION OF EXEMPLARY EMBODIMENTS OF THE INVENTION

The present invention includes a method and system for shopping from a remote location, and providing the purchased goods in a storage device facility for the user to pick up during a chosen time slot or interval. Advantageously, the present invention allows people to shop at a time when it is convenient to access a computer, and then to pick-up the purchased items at a chosen location during a reserved time slot. The present invention also allows conventional brick and mortar stores to have a viable and marketable presence in the virtual or Internet world. Typically, Internet-based shopping companies initially start with little to no product inventory. In fact, many these “dot com” shops do not maintain any inventory, but rather, act as a middle man and facilitate other transactions. Conventional brick and mortar stores face the risk of losing business to these types of companies simply because they do not offer a more convenient method in which to offer their goods to the consumers. The present invention alleviates this concern and brings the shelves of the local grocery store, hardware store, or the like, into the living room, office, or handheld mobile computing device of the consumer, yet do not subject the consumer to the constraints of mail or courier delivery of the goods.

There are several possible embodiments of the present invention. In one embodiment of the present invention, a user may shop for groceries from home, work or other location, and then drive to another location at a convenient time to pick-up the groceries. Other embodiments of the present invention may also be used to purchase and pick-up electronic items, hardware, laundry, video cassettes, pizza, fast food, or any other retail item. Furthermore, instead of purchasing the goods over the internet by accessing the store website, the user could order the goods via a kiosk located outside the store or through a communication means, such as a touch screen, located at the store or within a storage unit in a storage device at the store, or in a different location.

In an exemplary embodiment of the present invention, a user terminal at a remote location is used to access a shopping program. The user terminal may be a personal computer, a dummy terminal, a handheld wireless device, a television set equipped with “WEBTV” or other similar capability, a telephone with a voice response unit, a fax machine, a teletype machine or other similar devices. The shopping program may be an application loaded onto the user terminal or it may be a web-site accessed by the user terminal running a web browser or a wireless application protocol (“WAP”) browser over the Internet or a local area network. The shopping program may take on a variety of configurations and the present invention anticipates the use of any of a variety of these programs. In general, the user may select and purchase items through the use of the shopping program. The shopping program will identify the goods to be purchased, the purchase price, the availability of the goods, and related goods that the consumer may want to consider. However, those skilled in the art will realize that other types of information may also be provided to the user depending on the types of goods and the type of store offering the services available through using the present invention.

A server system is located in, or communicatively coupled to a merchant interface device, such as a printer or display device at a store, warehouse, or other shopping or storage facility. As more fully described below, the server system may also be coupled to an assembling means that can identify and select purchased goods and deliver them to a storage device. Such assembly means may be automatic and performed partially or totally by machines. The assembling means may comprise an entirely automated store or warehouse which receives a list of desired goods, obtains the desired goods and deposits them within the storage unit. In one embodiment of an automated store or warehouse, each item of merchandise is coded, perhaps with bar codes, and located in predetermined areas for access by robotic pickers that obtain the item and transport it through transportation means to the storage locker. Such means may include, but are not limited to, conveyors, transport in a cart accessible to the robotic picker or attached to the robotic picker, or other means.

It should be understood that the server system may also house the shopping program and be accessible by users via a website on the Internet, a local area network, a dial-up modem, or other similar communication means. The server system also interfaces with a storage device system.

Various types of storage device systems may be used in various embodiments of the present invention and the present invention anticipates the use of any of these varieties of storage devices, such as lockers, bins or larger units such as the size of a closet or room. The storage unit may be any desired size for the merchandise stored within. The interface between the server system and the storage device system may be of any variety including wireless, wired or optical communications in any of a variety of analog or digital communication protocols.

In the exemplary embodiment, the server system operates as the master, or central controller. The server system can control the operation and obtain the status of the storage device system. A typical storage device system will include multiple units or lockers and one or more control panels for accessing the units. In an exemplary embodiment, the units will open from both sides. One side is used by store personnel or pickers to load the storage device and units while the other side is used by customers to obtain their purchased goods. The access panel allows the user to enter a code, password or other personalized information in order gain access to the unit. The access panel may be configured in numerous ways, including but limited to the following: for receipt of an access code; to read a fingerprint; to perform a retinal scan; to read magnetic strips on cards; and to recognize a voice.

The storage device system may also be passive. In this embodiment of the present invention, the storage device system does not automatically transmit data to the server system, but rather, the server system polls or interrogates the storage device system to obtain status information about the storage units within the device. Typical status information includes, but is not limited to (a) a door being open or closed, (b) a storage unit being full or empty, (c) a storage unit being out of service or in service, (d) the temperature or humidity of the interior of a storage unit, or other characteristics. In another embodiment of the present invention, the storage device system may be active. In this embodiment of the present invention, the storage device system may autonomously transmit status information to the server system via communication means.

In one embodiment of an active system, the storage device may transmit information to the server system through communication means, including but not limited to the following types of information: emergency information concerning a failed or failing temperature control or humidity control system; vandalism or other attempts at unauthorized entry, for example through repeated use of unauthorized access codes; fire; electrical failure; power failure; frequency of use; information from the consumer concerning incorrectly or incompletely filled orders; and information from the consumer concerning damaged goods or goods spoiled due to a loss of temperature or humidity control. Some of this information generated from the storage device may be directly or indirectly routed to the police, a security company, a fire station or the power company. Consumer-generated information concerning incorrectly or incompletely filled orders or damaged goods may then be used to obtain a credit to the consumer's account, to order replacement goods for subsequent delivery, and to notify the vendor of the damaged goods or incompletely filled order that problems exist which require attention. Consumers may also use the communication means within the storage unit to shop for additional goods, pay for the goods, and reserve a storage unit within a storage device at a desired location and for desired time interval.

Communication means for communicating between the storage units, the storage device terminal system, and the server system include, but are not limited to, any form of wired and wireless communication means, including phones, cell phones, cables, satellites, computer terminals, keypads, pagers, card readers, and touch screens.

In either of the embodiments, the server system and/or storage device terminal system may internally maintain a status image of the entire storage device system and all units contained therein, or alternatively, may rely on continuous or periodic access to the storage device system to determine the status.

In one embodiment of the present invention, the units may be climate controlled, including temperature and/or humidity control, in order to accommodate foods which must be frozen or refrigerated. In other embodiments of the present invention, the storage units may be climate controlled to keep food items warm, prevent items from being exposed to moisture, or the like.

In addition, the storage devices and units may be equipped with detection systems. Detection systems include but are not limited to the following: systems that detect unauthorized entry; systems that detect fire, power failure or reduction; systems that detect entry into the locker, such as infrared motion detectors and weight detection systems. Weight detection systems allow the system to determine when items have been removed from the storage locker, and if the locker is partially or completely empty. It should be understood that other techniques to determine when the items have been removed from the storage device may also be used such as optical sensors, sonar, actuator switches, or the like. A detection system, detecting for example that a unit is empty, may communicate this information to the server so that the server may prompt the pickers and other assembling means that the unit is available for stocking the order for the next customer. The server may also send a message to the next customer through communication means that he now has the option of picking up his order at a time somewhat earlier than the pre-reserved time interval. This customer may exercise this option and send a message to the server through communication means indicating that an earlier time for pick up is acceptable.

In another embodiment of the present invention, storage devices and units are configured with a slot, or movable door and receiving bin so that the user may send packages, envelopes or letters through the unit. Users may also receive packages, envelopes or letters through the unit. Both delivery and pick-up of parcels may be coordinated by any delivery company such as the United Parcel Service, Federal Express, DHL or the United States Postal Service. This embodiment is discussed further in the Examples.

### Automatic Distribution Systems (ADS)

It is to be understood that the distribution systems and storage devices of the present invention may be configured in a variety of ways. These distribution systems may also be located in different settings, thereby allowing a multiplicity of uses. In one embodiment, the automatic distribution system (ADS) may be located in a retail store setting. In one embodiment of the present invention, an ADS may be used in association with a store. The ADS may be temperature-controlled in order to protect temperature-sensitive objects. In one embodiment, a distribution system may be installed directly into the side or front of a store so that storage unit doors or openings face the outside for access by consumers and loading doors face the interior of the store for access by pickers or other assembling means. This embodiment is particularly advantageous to use in locations that are notorious for high crime rates. Since customers would pay for their purchases online, no cash transfer would be required. Furthermore, the convenience store operator would be protected from potential criminals since customer access to the store could be highly regulated or even eliminated. If the store utilized the ADS system as its sole means of distributing merchandise, there would be no need for customers to access the interior of the store. All access could be through the ADS which would house the goods ordered by the customer. A benefit of this configuration of the ADS in a secure retail environment is that costs for security personnel and other security surveillance systems are reduced or eliminated. Furthermore, since there is no cash flow in this model and no access to the interior of the store, the incentive for larceny and robbery is reduced, thereby decreasing losses due to theft. In addition, this system decreases danger to customers and convenience store personnel which are routinely encountered during a robbery, particularly an armed robbery.

In another embodiment of the present invention, an ADS may be utilized in the retail and shopping mall industries. This ADS may sit outside a retailer's store or at an entrance to a shopping mall. Numerous retail stores could access an individual storage unit. In this manner, a customer may place orders with one or more stores in the mall. Following receipt of the order, a picker in the one or more stores may obtain the merchandise selected by the customer and transport it to the storage unit for pick up by the customer during the time interval or slot determined by the customer in conjunction with the reservation system. Through the use of this ADS system, a customer may shop various stores in the mall without entering the individual stores within the mall. This system has the advantages of decreasing human congestion, decreasing cash transfers resulting in lower incentive for theft both by burglars and possibly by store personnel, decreasing crimes such as shoplifting, decreasing costs of security personnel in individual stores and in the mall in general, and lowering insurance rates due to decreased probability of theft. This system provides additional advantages to consumers in terms of facilitating access to the diversity of stores providing different types of merchandise while decreasing the need to shop the individual stores. This system is particularly advantageous for individuals who may suffer from various disabilities that affect their mobility, speech, and psychological capability to accommodate large crowds found within shopping malls. This system also provides for superior monitoring of inventory by store managers. Orders placed on line can easily be indexed, such that individual stores can maintain inventory control and closely monitor the sale of popular items thereby initiating requests for shipment of these items from distributors to maintain inventory within the retail outlet store. This system also permits customers to shop in a web environment and receive their selected goods at their convenience. In this manner, stores, through the use of their pickers who fill the orders, may stock individual ADS lockers at any time selected by the customer through the reservation system so that the customer may pick up his order at his convenience. It is anticipated that customers may pick up orders at any time of the day or night, depending on their individual schedule. This system further alleviates the extreme congestion and loss of time incurred by customers during particular high-volume shopping periods such as holiday seasons, for example, in the period between Thanksgiving and Christmas or Hanukkah.

It is to be understood that any type of store may utilize the present invention. For example, an individual customer may place orders at a sporting goods store, a video rental store, a book store, a store selling compact discs, and a department store conducting a one-day sale of jewelry. Following assignment of a reservation time interval for pick up at the storage unit, merchandise pickers from the different stores would gather the merchandise selected by the customer and place it in the unit at or before the customer's reserved pick-up time. The customer would arrive at her selected pick-up time, access and open the unit, inspect the merchandise, and if all purchases are correct, remove the merchandise, close the door to the unit and leave. By utilizing the present invention and shopping online, the customer has saved hours of valuable time which would have been wasted entering each individual store, locating the desired merchandise, waiting in a check-out line, fighting human congestion within the mall, locating the car within the parking lot and driving away. Shopping malls may optionally hire security personnel to provide security in the location of the ADS unit.

In another embodiment of the present invention, the ADS unit is designed with the grocery industry as the supplier of merchandise. This ADS unit is climate-controlled and optionally contains a complete walk-in cooler which is fronted by a plurality of locked doors. A customer may access the store's inventory of groceries through the internet. The customer may select the desired items and reserve a pick-up time through the locker reservation system. Alternatively, a customer may maintain a standing order of items that are routinely purchased by the customer. A standing order placed with the store need only be filled by the store on a pre-selected time-dependent basis; for example, every week. Once a pick-up time interval has been assigned to the customer through the reservation system, the customer simply travels to the ADS unit, opens the door during the pre-selected time interval, removes the groceries and leaves. In another embodiment, a customer may have a standing order which may be supplemented through the selection of additional items to be obtained by merchandise pickers within the grocery store. This system provides significant advantages and benefits to the consumer and also to the grocery store owners. In addition to reducing congestion within the grocery store, especially during peak periods such as between 4:00 p.m. and 7:00 p.m., this system reduces time lost to the purchaser by eliminating the need to search for a shopping cart, travel down long aisles of groceries, search for the item desired, interact with personnel within the store, such as butchers to select a particular cut of meat, stand in check-out lines and then transport the goods to the vehicle for the ride home. Another advantage of the system of the present invention is that the groceries are maintained in a fresher state since the climate-controlled storage unit provides the requisite temperatures for maintenance of proper storage conditions, especially important with dairy products, beef, chicken and fish. Again, as in the examples described above, the store benefits from decreased personnel costs and labor costs involved not only with inventory control but also with check-out clerks and baggers. Furthermore, the grocery store benefits from reduced security costs since fewer cash transfers occur and since the potential for theft by customers or store personnel is reduced.

In another embodiment of the present invention, a pharmacy may receive prescriptions sent by a customer or by a physician or other health care personnel prescribing a therapeutic substance. The pharmacy may fill the prescription and then place the prescription, together with any other items the customer wishes to purchase from the pharmacy, in the storage unit in the ADS during a time slot agreed upon by the customer through the reservation system. The customer then opens the door and gains access to the unit through the security means described above, removes the desired prescription and/or additional merchandise, closes the door to the unit and leaves. This system provides significant benefits to the customer in reducing time lost waiting for prescriptions to be filled. This is particularly advantageous since the customer waiting for the prescription is often ill or feeling poorly and in need of the prescription. Many other customers are elderly and require multiple prescriptions to be filled on a routine basis. This system provides more convenient access to the prescriptions necessary for maintenance of good health and decreases the inconvenience and discomfort associated with ill and elderly people waiting for their prescriptions to be filled. Furthermore, this system provides pharmacists with more predictable work schedules, especially if certain prescriptions are to be filled on a standing order basis. For example, certain medicines may be required routinely by individuals and a pharmacist holding a standing order from a customer or a physician may fill these prescriptions at times when the walk-in customers holding paper prescriptions are fewer in number. By decreasing the stress on pharmacists due to sudden demands of walk-in customers, the probability for error in filling prescriptions is greatly reduced.

In another embodiment of the automatic distribution system, humidity control may be added to the unit. Proper humidity control within the locker is essential for a variety of purposes. For example, the retail distribution of quality line requires maintenance of proper humidity levels so that corks of wine bottles are sufficiently moistened in order to prevent cracking. This is especially important in areas of low relative humidity. Incorporation of a misting system activated by a humidistat facilitates maintenance of a desired relative humidity. In addition, heating units may be added to maintain the desired humidity by burning off excess moisture in very humid environments.

### Independent Distribution Systems (IDS)

In another embodiment, a distribution system encompassed within the present invention is an IDS. This system and storage device may be placed virtually anywhere and used as independent distribution center. A plurality of openings may be placed on one or more sides of the storage device. In a preferred embodiment, user doors are present on all four sides. One main access door is provided on one side for pickers or other delivery personnel to load the individual storage units. In one embodiment, the IDS unit maintains temperature control. This IDS is especially advantageous in areas of the country where consumers are widely separated from retail or wholesale outlets. For example, in rural communities, farmers would benefit from access to an IDS which would be supplied by various retail and wholesale vendors. A farmer could pick up groceries, veterinary therapeutics for livestock, feed for livestock, video cassettes, items from the pharmacy and even postage stamps. In this manner, the farmer, perhaps traveling 60 miles to the distribution center to obtain the goods during the pre-reserved time interval might save an additional 80 miles of unnecessary driving from the pharmacy to the grocery store to the animal feed store and to the video rental store and the post office.

This IDS is also advantageously placed in suburban areas in any desired location. In one embodiment, the IDS may be placed near a shopping mall, so that stores within the mall may fill customers' orders by picking the goods and depositing them within the reserved storage unit within the IDS, during or before the time interval reserved by the customer for pick up of the goods. In this manner, a customer obtains the benefit of purchasing goods from numerous stores within the mall without the entering the mall, wasting time, fighting crowds of shoppers, waiting in check out lines and conducting numerous transactions.

The owner of the IDS may also configure the system so that delivery companies, for example, United Parcel Service, Federal Express, DHL or the United States Postal Service, could deliver to the same IDS and to the individual storage units associated with the recipient of the delivery. By accessing an IDS, these delivery companies may deliver goods to a plurality of recipients with one stop. The savings in terms of decreased expenditure of fossil fuels for transporting goods to a plurality of recipients is substantial. Further, the delivery company saves extensive labor costs since the amount of time required for making the same number of deliveries to recipients is dramatically reduced. The net result of this approach is a reduction in lost fuel and in labor, thereby decreasing overall costs to the consumer and decreasing the burden on the environment. In addition, the recipients benefit this system by ensuring that they will receive the delivery at a time when they are available to pick it up. Frequently, delivery companies are thwarted in their attempts to deliver parcels to recipients since the recipients are not present at the time when the delivery company appears at the recipient's location. Such missed deliveries are extremely inconvenient since the parcel is returned to a local distribution center, the intended recipient is notified of the failed delivery attempt and then must travel to the distribution center to receive the parcel. Furthermore, the parcels are frequently left outside the recipient's door. These parcels are subject to vandalism, theft and damage due to weather conditions, resulting in a lost of merchandise and sometimes insurance claims against the delivery company or the supplier of the merchandise.

It is to be understood that the IDS system is not limited to customers who are end consumers for the goods being placed in the units. Depending on the configuration of the IDS system and the specific merchandise and its size limitations, the IDS may be employed by retailers receiving supplies from wholesalers.

### Warehouse Distribution Systems (WDS)

In another embodiment, a distribution system encompassed within the present invention is a warehouse distribution system (WDS). This system may be directly attached into a side or exterior wall of a warehouse. A warehouse may utilize the WDS to deliver to customers whether the customers be retail store owners or individual and consumers. Such WDS units may optionally contain humidity controls and/or temperature controls.

In one embodiment, a humidity controlled WDS unit is further equipped with temperature control and is used to store wine. A wine warehouse may supply retail wine distributors as well as individual customers through the use of the WDS. Maintenance of proper humidity levels and temperature ensures that the wine will be maintained in optimal storage conditions thereby preventing cracking of the cork or other deleterious effects of extreme high or low temperatures. A retail store owner may decrease costs associated with purchase of wine from the wholesaler at the warehouse by using the WDS system since transportation costs from the wholesaler to the retailer would be eliminated. Furthermore, the retail store owner can schedule pick-up of the desired items at his or her convenience, thereby decreasing disruption in retail store operations when the delivery truck from the wholesaler arrives. The individual consumer realizes significant cost benefit through the operation of a WDS since the individual consumer buying directly from the warehouse eliminates the mark-up in price by the retailer who is no longer part of the transaction. In addition, the individual consumer may purchase a quantity of wine and the variety of wine desired and thereby avoid uncertainties in inventory supply at the retail store. The individual consumer also realizes the benefit of convenience, avoids the need to travel to and enter the individual retail store and can pick up the item at any time including times which are proscribed by law for the sale of alcohol.

In another embodiment, a WDS system may not require temperature control or humidity control. Such a unit may be beneficial in any type of dry goods or electronic warehouse application. In yet a further embodiment, a WDS system may be refrigerated. This system would have application in a variety of settings, for example in the dairy industry where a milk producer could make available significant quantities of milk to a retail store or directly to an individual consumer at the warehouse. Again, this would have the benefit of decreasing costs by eliminating transportation costs and potentially eliminating the retailer as a middle man in a consumer transaction.

WDS units may be configured with or without a door to each unit or to the entire device on the warehouse side of the unit. Some warehouse applications, for example, warehouses selling dairy products or meat products, may require special temperature conditions. The refrigerated air may flow freely into the individual units of the WDS when no doors are present on the warehouse side of the WDS. Individual temperature control may be added to each unit if desired. The WDS unit has a door for each unit on the exterior of the unit for access by the customer.

Referring now to the figures in which like numerals refer to like elements throughout the several views, various embodiments and aspects of the present invention are described. Although the present invention is described as using the internet and storage lockers, those skilled in the art will appreciate that the present invention may be used in conjunction with other mediums which may be used to connect the user with the retailer, such as a network, and any other device which may be used to store goods.

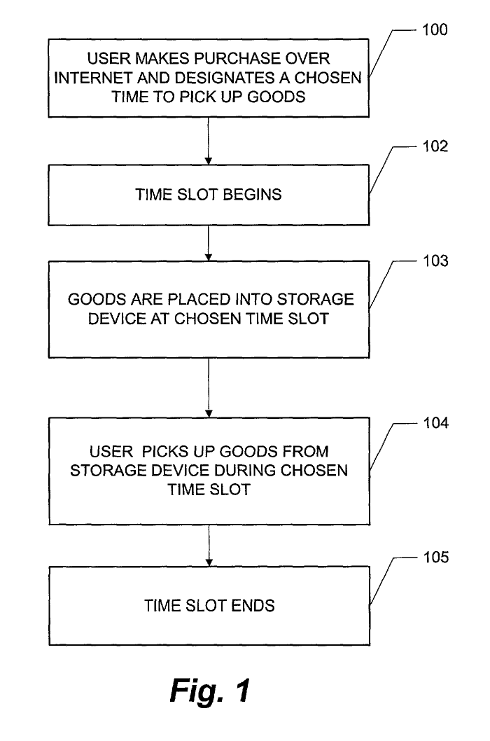

FIG. 1 is a simplified flow chart illustrating the business transaction resulting from the method and system of the present invention. After accessing the merchant website, the customer makes a purchase of goods from the merchant inventory. The customer, while checking out, will designate a chosen time interval or slot in which to pick up the goods. This step is shown in 100. When the time slot begins 102, the goods are placed into the storage device 103. The customer picks up the goods from the storage device during the time slot 104 before the time slot ends 105.

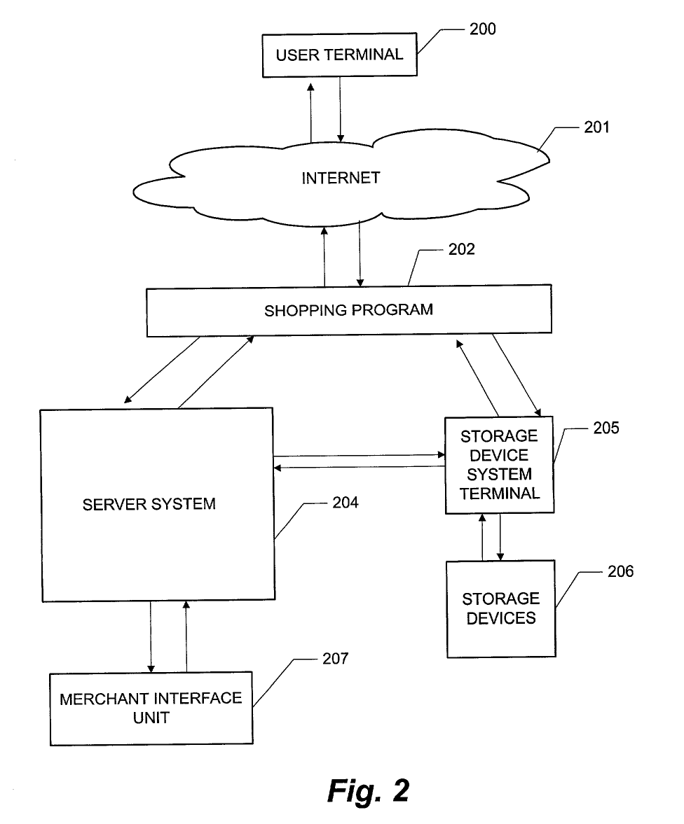

FIG. 2 is simplified diagram of the system of the present invention. The user terminal is a terminal which is used by the customer to access the merchant website. The internet 201 connects the user terminal 200 and the shopping program 202 on the merchant website. The merchant website interfaces with a store inventory database. Each store associated with the merchant will have its own separate database which stores all of the available inventory of that store. On the merchant website, the user will input the store from which the user desires to purchase goods. The store inventory database of this store then is accessed by the merchant website. In this manner, the user can browse or search only the inventory which is available from the selected store. The merchant website is connected to a merchant interface unit 207 and a storage device system terminal 205. The merchant interface unit 207 communicates the order placed by the user to the merchant, so that the assembling means can assemble the order. The storage device system terminal 205 is connected to the retail website 202, and communicates between the retail website and the storage device 206.

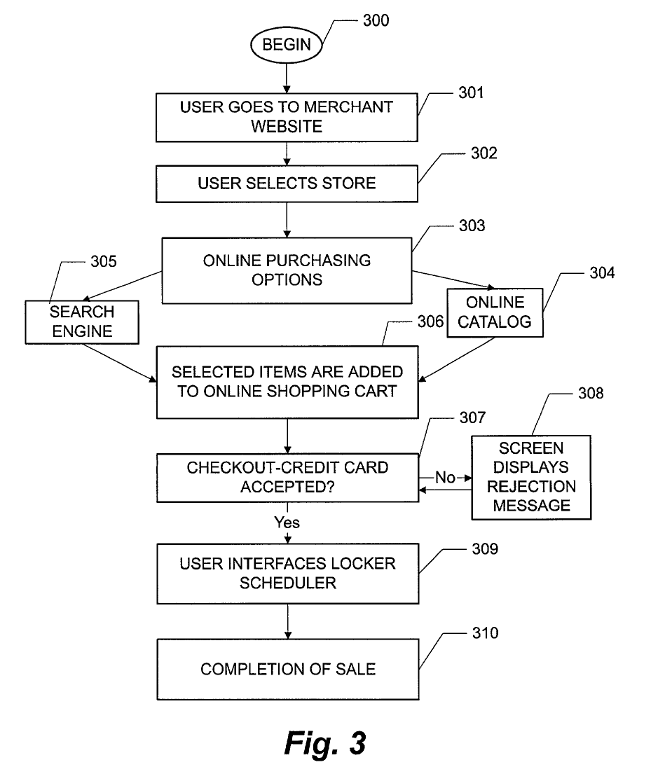

FIG. 3 is a flow chart diagram illustrating how goods are purchased in the method. The method begins at 300 with the user accessing the merchant website 301. The merchant can represent a conglomeration of stores, such as a grocery store chain with several branches. In order to have the website provide only the inventory for the desired store, the user must choose which store is desired 302.

Once the store is chosen, the customer has two online purchasing items for buying the products online 303: the search engine 305 and browsing the online catalog 304. The search engine 305 allows the user to enter a keyword or characteristic of the desired product, and then search the entire database for hits. These hits are presented to the user, and can be added to the user's shopping cart 306. The online catalog 304 allows the user to browse each item in the inventory, adding any desired items to the shopping cart 306.

At any time the user may proceed to checkout 307. At this time the user will be queried for a credit card number. The number will then be processed, and if the number is rejected, the screen displays a rejection message 308. This message, for example, could offer for the user to call customer service, or submit another credit card number.

After credit card processing 307, the customer will interface the storage device schedule 309. The storage device scheduler, which will be explained in further detail in the remaining figures, will query the user for a time slot, and then return a storage device assignment with a combination which will open the storage device for the chosen time slot. The sale is now completed 310, with customer receiving a confirmation or thank you email generated from the merchant website.

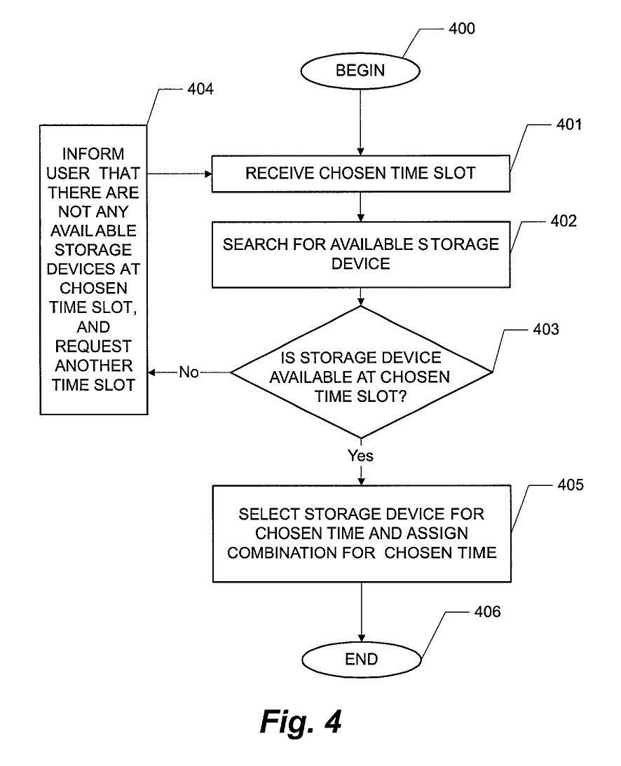

FIG. 4 is a flow diagram illustrating how the storage device scheduler handles reservations of lockers. The method begins at 400, and the storage device scheduler receives the chosen time slot at 401. The time slot is queried from the user, and can be in hour increments for example. Once the chosen time slot is received, the storage device scheduler searches 402 to see if there are any lockers available during the chosen time slot 403. If there are no lockers available for the chosen time slot, after the scheduler notifies the user that there are not any lockers available for the chosen time slot, the customer is queried for another time slot 404. Once the alternate time slot is received 401, the scheduler searches for an available storage device again 402 to see if there are any available lockers 403. This process may continue several times before finding an available locker.

Once the storage device scheduler determines that there is a storage device available, the storage device scheduler sets the storage device with a combination for the chosen time, and enters the storage device as unavailable during the chosen time slot 405. The combination can be user chosen, or generated by the storage device scheduler. The resulting storage device number and combination can be sent to the user via email, displayed on the screen, or both. The process ends at 406.

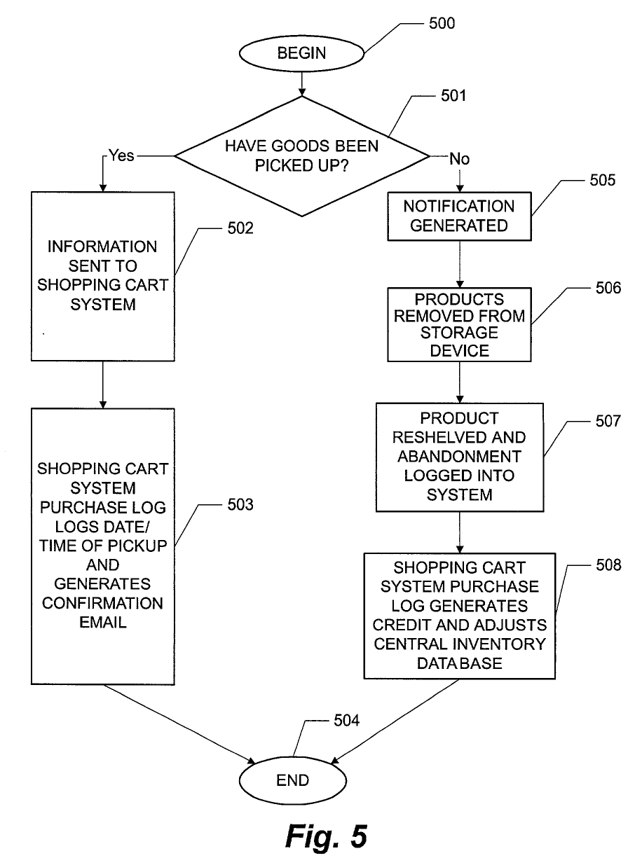

FIG. 5 is a flow diagram illustrating the storage device scheduler at the conclusion of the time slot. Occasionally, a user will be unable to arrive at the storage device at the chosen time slot to pick up the purchased products. Therefore, after the chosen time slot ends 500, the storage device scheduler determines if the goods have been picked up 501. This may involve a sensing device within the locker, or a determination that the combination was entered into the storage device during the time slot.

Another possibility is a light indicator. If the customer using the storage device at the conclusion of the time slot has yet to remove the goods and vacate the locker, a light indicator will signify the continued presence of the goods in the storage locker. At this time, an error message will be sent, and the system will continue to try to upload the locker. If the customer is in the process of removing the purchases from the storage device at the conclusion of the time slot, the system will respond in the same manner by the light indicator signifying the continued presence in the storage locker, sending an error message, and continuing to try to upload the storage locker.

Once the storage device scheduler has determined that the goods have been picked up at 501, then the information surrounding the transaction (for example, time of pickup, storage device number, receipt, and store location) is sent to the shopping cart system 502. Once the shopping cart system has received this information, the purchase log for the particular store is updated with the date and time of pickup 503. Also, a confirmation/thank you email may be generated and sent to the user 503 before the process ends 504.

If at step 501, the storage device scheduler determined that the goods had not been picked up, then a notification 505 is generated to the storage device system terminal, indicating that the goods are still in the storage device. At this time, the products are removed from the storage device 506. The products are reshelved 507, and the order is entered into the system as “abandoned.” At this time, the shopping card system must refund the money which was paid by the customer because the order was not picked up. Thus, the shopping card system will issue a credit on the credit card equal to the amount paid 508. The store inventory is then adjusted to reflect the products which were re-shelved as part of the store's inventory 508 before the process ends at 504.

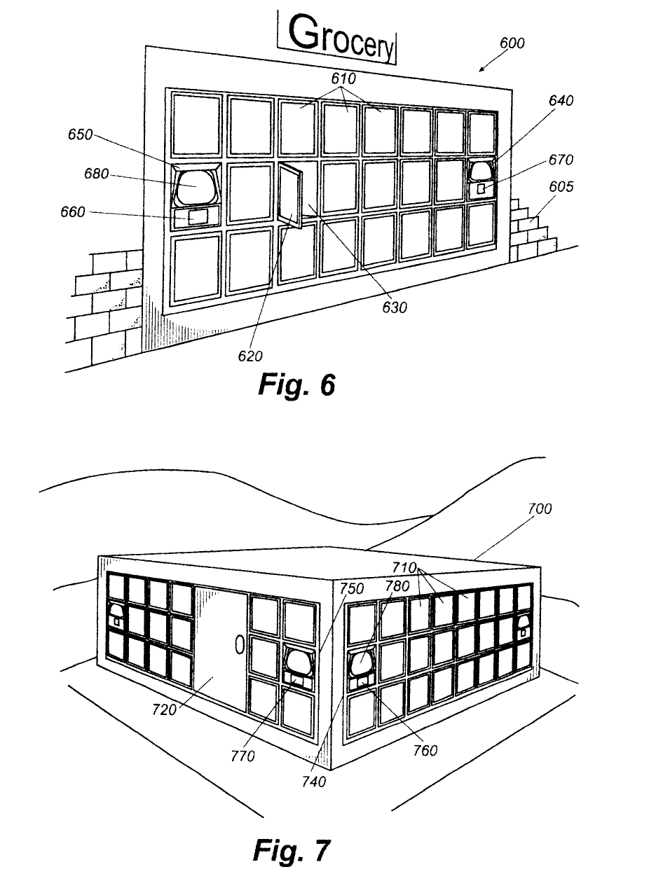

FIG. 6 is a schematic representation of an automatic distribution system (ADS) 600 installed in the wall 605 of a grocery store. A plurality of exterior doors 610 to the storage units are shown. One door 620 is open, providing access into the storage unit 630. Two exemplary communication terminals, 640 and 650, provide a data entry means, in this case a keypad 660 and touch screen 670. A monitor 680 is also provided.

FIG. 7 is a schematic representation of a free-standing independent distribution system (IDS) 700 located in the country. A plurality of exterior doors 710 to the storage units are shown. One larger door 720 provides access into the interior of the IDS 700 for delivery personnel to make deliveries into individual storage units. Two exemplary communication terminals, 740 and 750, provide a data entry means, in this case a keypad 760 and touch screen 770. A monitor 780 is also provided.

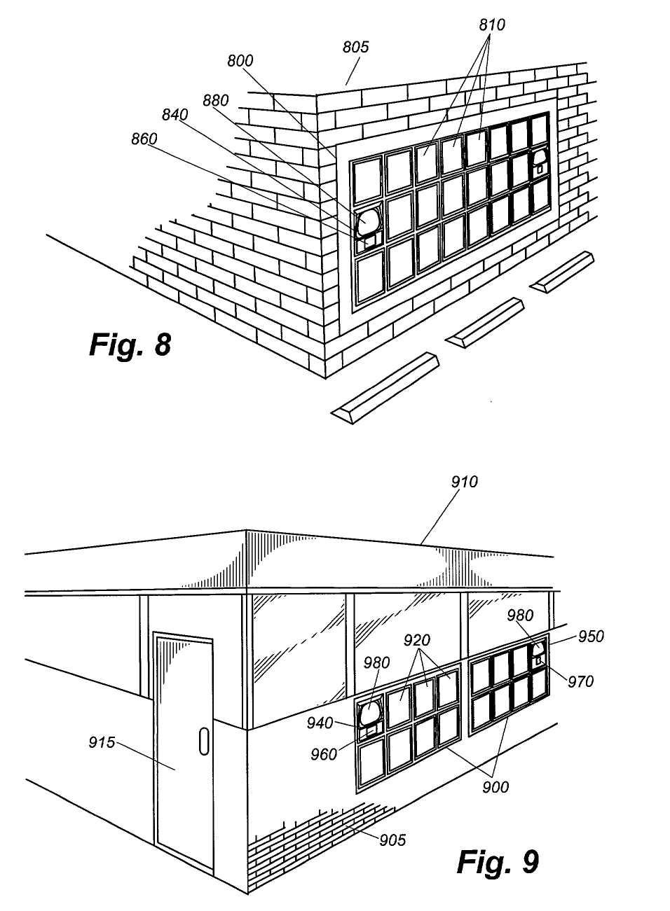

FIG. 8 is a schematic representation of an warehouse distribution system (WDS) 800 installed in a wall 805 of a warehouse. A plurality of exterior doors 810 to the storage units are shown. An exemplary communication terminal, 840 provides a data entry means, in this case a keypad 860. A monitor 880 is also provided.

FIG. 9 is a schematic representation of an temperature-controlled automatic distribution system (ADS) 900 installed in the wall 905 of a convenience store or grocery store 910. One larger door 915 provides access into the interior of the grocery store 910. A plurality of exterior doors 920 to the storage units are shown. Two exemplary communication terminals, 940 and 950, provide a data entry means, in this case a keypad 960 and touch screen 970. Monitors 980 are also provided.

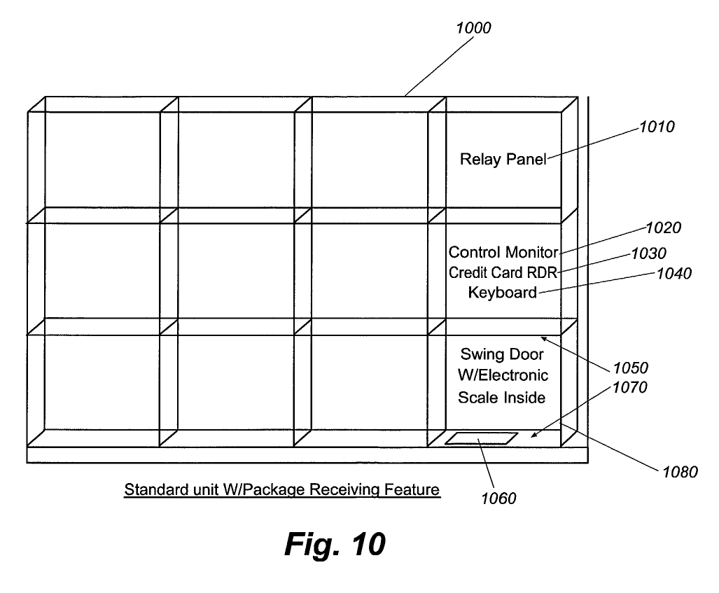

FIG. 10 is a schematic representation, cut away view, of the assembly 1000 that may be added to individual storage units for sending packages and other items. Schematically illustrated are a relay panel 1010, a control monitor 1020, credit card reader 1030 and keyboard 1040 for entering and reviewing information. A swing door 1050 is located on the back wall of the storage unit. A weighing scale 1060 is located in the floor 1070 of the storage unit 1080.

By the use of this system, the customers will have quick access to the goods, the storage lockers will maximize their turnover of the lockers by the use of the time slots during which the customers pick up their goods.

The following examples are illustrative embodiments of the invention, not limiting the scope of the invention in any way. It will be appreciated that other embodiments and uses will be apparent to those skilled in the art and that the invention is not limited to these specific illustrative examples.

### EXAMPLE 1

### Automatic Distribution System for Use in Convenience Stores

Developed for convenience store applications this model is installed directly into the side or front of the store so that the locker openings are facing outside and the loading doors are facing into the store. The entire unit is temperature controlled.

### EXAMPLE 2

### Automatic Distribution System for Use in the Retail and Shopping Mall Industries

This system is designed to be used by the retail and shopping mall industries. It is non-temperature controlled and sits outside of the retail store or at the entrance to a shopping mall. It has a minimum of 22 openings and is loaded from the rear, through locked access doors. EXAMPLE 3

### Automatic Distribution System for Use in the Grocery Store Industry

This unit is designed for the grocery store industry and has a complete walk-in cooler that is fronted by a minimum of 22 locked openings. Access for loading is gained through a door between the store and the cooler. There are two control monitors, with touch screens at either end of the bank of lockers, for easy code entry by the consumer.

### EXAMPLE 4

### Automatic Distribution System Containing Humidity Control for Use in the Grocery Store Industry and Wine Distribution Industry

This unit is similar to the unit described in the preceding example but also contains humidity control in the form of a Fractal Micron Misting System. This system is activated by a humidistat and maintains a 60% relative humidity within the storage chambers. Excessive moisture is removed with a Russell Reheat kit in order to maintain the selected relative humidity.

This unit is used in the storage of produce, cut flowers, and wine. Produce and cut flowers are maintained at the selected humidity to prevent wilting. Bottles of wine are maintained at the selected humidity to keep corks properly moistened and prevent cracking.

### EXAMPLE 5

### Independent Distribution System

This temperature-controlled system is used as an independent distribution center and is placed as a stand alone unit in almost any location. The unit contains a minimum of 84 openings on four sides, with one main access door for loading purposes. This unit permits one or multiple deliveries from one or multiple vendors during a reserved time interval. A grocer feeds this system directly from a warehouse on a regular basis. A pharmacist makes a delivery of a prescription for the consumer. A video cassette entertainment store delivers three selected movies. A parcel delivery service, such as the U.S. Postal Service, DHL or United Parcel Service, makes a delivery of a package to the locker. Each of the deliveries is coordinated through the web and the reservation system to inform the different vendors of the pick-up time selected by the consumer, the location of the independent distribution system, the locker assigned to that consumer, and the time interval assigned to the locker for receipt of deliveries before the consumer's arrival. The customer arrives at the reserved time and enters the access code. The locker opens itself up when the proper code is entered, thus there is no confusion to the customer and this simplifies the retrieval process. The door remains in the open position for three to four minutes, closes and then automatically re-locks the lock and resets the code for the next user. This system can be increased in size in increments of twenty-four openings, with all electronics and controls included. Given the relatively inexpensive cost of this system, almost any business interested in providing their customers with the latest and most efficient method of e-commerce fulfillment can utilize the IDS. The owner of this independent distribution unit contracts with each vendor to permit access to the unit for delivery of goods to the lockers assigned to consumers.

The IDS can be upgraded with any future improvements or significant changes to its' operating system, without disrupting service, as this system has been developed around a standardized, modular design of door systems and electronic controls.

### EXAMPLE 6

### Warehouse Distribution System with Temperature and Humidity Control

The warehouse distribution system is attached directly into the side or rear exterior wall of a temperature and humidity controlled warehouse, thereby creating another use of the particular warehouse, giving the warehouse the option of direct delivery to their customers as well as pick-up at the warehouse by retailers. By utilizing the existing temperature and humidity control inside the warehouse, the warehouse may distribute goods directly to their local clientele at the warehouse and avoid the need to use a vehicle or delivery service. With a minimum of 22 locked openings and two control monitors, this unit is ideal for warehouse distribution.

### EXAMPLE 7

### Warehouse Distribution System without Temperature Control

This model of a warehouse distribution system has all of the same basic characteristics as the preceding example without the temperature control systems. The system is designed for use in any type of dry goods or electronic warehouse application. A large home supply store, such as a Home Depot, Lowes, K Mart, Walmart or other store that sells merchandise such as hardware, light bulbs, floor tiles or any item useful in the home or garden, devotes a portion or the entirety of a wall of the store for a plurality of lockers. Customers use the web based reservation system to place their order, the order is obtained by pickers within the store and placed within the locker during the appropriate reserved time interval preceding customer arrival for pick up. The consumer arrives at the outer wall containing the plurality of lockers during the reserved time interval, enters the assigned code, opens the door, removes the merchandise, and closes the door.

### EXAMPLE 8

### Warehouse Distribution System with Refrigeration Control

This unit is located in a wall, in a refrigerated warehouse environment, with easy access within the warehouse for placing refrigerated goods inside the unit. This unit may be configured to maintain open access to the interior of the warehouse, thereby permitting flow of low temperature air into the locker opening facing the warehouse. In another configuration, a room separates the warehouse from the lockers open on the warehouse side so that the net effect of repeated opening of the outer locker door by the consumer does not adversely affect the temperature within the warehouse. In yet another configuration, a door is present on the warehouse side of the locker and also on the consumer side of the locker, and the locker is refrigerated so that the goods are maintained in a refrigerated state and the effects of door openings and closings on the warehouse temperature are minimized.

These configurations permit the ordered goods to continue to be refrigerated while waiting for customer pick-up. Dairy products and eggs requiring storage at refrigerated temperatures to reduce bacterial growth may be delivered directly to the consumer without employing refrigerated trucks or other vehicles to deliver the goods to a retail store. Costs are reduced by eliminating delivery of the goods from the warehouse to the retail store and by eliminating price markup by the retail store.

### EXAMPLE 9

### Pick-up and Drop-off Center Configured Within an IDS or ADS

In another embodiment of the present invention, an IDS or ADS is configured for delivery of parcels addressed to the user, or other merchandise ordered by the user, at time slots reserved by the user through the server. Such deliveries may be made by any delivery company such as the United Parcel Service, Federal Express, DHL or the United States Postal Service. In addition, the IDS is configured so that the user drops off parcels for pick up by a delivery company. This system obviates the need for the user to travel to a main facility, such as United Parcel Service center which may be far away, crowded and inaccessible during a convenient time available to the user. The user may weigh the package using an electronic scale or other weighing means, enter the address, zip code or other indicator of the destination through a data entry means, obtain a printed shipping label through a printing means, calculate the cost of mailing the item, make a payment with a credit card, obtain the necessary stamp or other indicia required for mailing, attach the label and stamp to the package and then push the package through a movable locking trap door in the floor, side or back wall of the storage unit, and into a guide shoot leading to a lockable receiving bin on the other side of the movable door. In one embodiment, the floor of the locker or receptacle in the IDS contains a weighing pan actuated by the user.

By using communication means in the receptacle in the IDS, the user can send a communication to the delivery/pick-up service that a parcel is ready for pick-up. In this manner, UPS or any other pick-up and delivery service coordinates pick-ups at IDSs throughout a region. Furthermore, both pick-ups from IDSs and deliveries to IDSs may be coordinated among IDSs throughout a region.

This system may also be added to ADS units located in stores contracting with delivery and pick-up companies.

This system saves pick up cost, including labor, fuel and wear on vehicles by centralizing pick ups to selected IDSs or ADSs as opposed to the numerous pick-ups at individual locations such as residences or offices. This system also alleviates the burden on regional drop-off facilities, especially during the holiday season. The use of this system is far more convenient to the individual user, allowing the user to mail a parcel at any time from the IDS, not just during the hours of operation of the regional drop-off facility, saving needless trips to regional drop-off facilities, lost time, fuel and wear on vehicles. The pick-up and delivery service could pay a fee to the owner and operator of the IDS for accessing the unit through a secure entry means and collecting the parcels from the locked storage bin.

### EXAMPLE 10

### Use of an ADS Located at a Grocery Store

An individual completes a long trip and arrives at his home airport at 11:00 p.m. The individual knows that no food is in his home, and that the stores will be closed when he completes the drive from the airport to his town. Before the last leg of his flight, he uses a hand held wireless unit operatively connected to the internet. After up-linking to the internet and accessing a web site for his preferred grocery store, he selects his preformed list of staple grocery items, supplements the list with items selected from the grocery store's website and requests assignment of a refrigerated storage unit for a specified time interval in an ADS storage device located in the wall of the grocery store. He pays for the order using a debit card code preprogrammed into the hand held wireless unit. After receiving confirmation of his order, confirmation of the requested unit and the requested time interval, and a combination for accessing the assigned unit in the ADS, he logs off the internet. The server communicates the information concerning the order, the assigned ADS storage unit and the assigned time interval to a merchant interface terminal in the grocery store. The information is displayed on a monitor, printed out, and pickers within the store obtain the groceries and deposit them in the assigned ADS storage unit at or before the assigned time interval.

After the flight lands, the customer picks up his luggage, finds his car in a remote parking lot, and proceeds to drive 2 hours to the ADS unit located in the wall of the grocery store. He inputs the combination, opens the door and begins removing the groceries that he ordered. When the removal is complete, the door closes and indicating means within the ADS unit transmits the vacant status of the unit to a server. The server then assigns this unit to the next traveling customer who is attempting to schedule a pick up at the same ADS early the next morning when the store opens since his flight is delayed significantly. The server then receives and transmits the grocery list of this customer to the merchant interface terminal so that grocery pickers within the store may obtain the desired groceries and place them in the ADS storage unit just before or at the beginning of the time interval assigned to this customer.

All patents, publications and abstracts cited above are incorporated herein by reference in their entirety.

It should be understood that the foregoing relates only to preferred embodiments of the present invention and that numerous modifications or alterations may be made therein without departing from the spirit and the scope of the present invention as defined in the following claims.

What is claimed is:

1. A method of purchasing goods from a merchant and delivering goods to a user, comprising:
a) an order step wherein, after communicating with a server system through a merchant website, the user selects one or more goods to purchase, the user places an order for selected goods via a user terminal;
b) an assembly step, wherein the order is communicated to an assembling means via a merchant interface unit, prompting the assembling means to take the goods from the merchant's inventory and assemble the order; and
c) a delivery step, wherein the order is placed by the assembling means in a storage unit for the user to pick up.

2. The method of claim 1, wherein the order step further comprises the user requesting a location of the storage unit and a time interval from the server system for the user to pick up the goods.

3. The method of claim 2, wherein the server system transmits the order to a storage device system terminal, which responds with storage information concerning storage units in the storage device, the storage unit and the time interval are assigned, and the server communicates the storage unit and the time interval information to the merchant interface unit and to the user.

4. The method of claim 3, wherein the user interface terminal displays the order information, the assigned storage unit and the assigned time interval.

5. The method of claim 1, wherein the assembly step comprises an assembling means placing the products in the assigned storage unit at or before the assigned time interval

6. The method of claim 3, further comprising assigning a security code to the user, wherein the user inputs the security code at the storage unit to access unit and obtain the goods.

7. A system for purchasing and delivering goods, comprising:
a) a server system which is coupled to a storage device system terminal;
b) one or more storage units contained in a storage device, the one or more units being coupled to the storage device system terminal and to the server system;
c) a user terminal, which is coupled to the server system; and
d) a merchant interface terminal, which is coupled to the server system.

8. The system of claim 7, wherein the storage devices are climate controlled.

9. The system of claim 7, wherein the merchant interface terminal is a printer which prints out a copy of the order.

10. The system of claim 7, wherein the merchant interface terminal is a monitor which displays the order.

11. A device for a user to purchase goods from a merchant, wherein the device is coupled to a server system with an inventory database of the merchant, the device comprising:
a) a user interface;
b) data entry means coupled to the user interface for communicating data to the user;
c) a program module which enables the user to
i) select goods for purchase from the inventory database of the merchant,
ii) select a storage device containing at least one storage unit using a storage device reservation system,
iii) select a time for the goods to be placed in a storage unit contained in a storage device using a storage device reservation system,
iv) pay for the goods by inputting payment information through the data entry means; and
d) a processing unit to execute instructions of the program module.

12. The device of claim 11, where the data entry means is a touch screen.

13. The device of claim 11, wherein the data entry means is a keyboard.

14. The device of claim 11, wherein the payment information comprises a credit card number, expiration date, and cardholders name.

15. The device of claim 11, wherein the payment information comprises a checking account number and check number.

16. A reservation system for allocating storage units in storage devices, comprising:
a) a storage device system terminal;
b) one or more storage units coupled to the storage device system terminal;
c) a server system which is coupled to the storage device system terminal;
d) a merchant interface unit coupled to the server system; and
e) a user terminal which is coupled to the server system.

17. The reservation system of claim 16, wherein the user terminal is coupled to the server system by accessing the server system through a website on the internet.

18. The reservation system of claim 16, wherein the one or more storage units comprise an indicating means coupled to the server system for indicating to the server system information about the status of the storage unit.

19. A reservation system for allocating storage devices, comprising:
a) one or more storage units;
b) a storage device system terminal which is coupled to the one or more storage units; and
c) an indicator means coupled to the server system or to the storage device system terminal for indicating information about the status of the storage unit.

20. A method of reserving storage units at different time intervals, comprising:
a) a time interval query step where a user queries a server system for a chosen time interval during which the user wants access to the storage unit;
b) an availability query step wherein the server system communicates with a storage device system terminal to determine if any storage units are available during the chosen time interval; and
c) an assign step, wherein the storage device system, after communicating with the server system that a storage unit is available for the chosen time interval, assigns a combination to the storage unit available for the assigned time interval, and communicates the location of the assigned storage unit and the assigned time interval to the user.

21. The method of claim 20, wherein the availability query step further provides that if the storage device system terminal communicates to the server system that there are not any storage devices available for the chosen time interval, the time interval query step is repeated, requesting the user to enter a time interval other than the previously entered chosen time interval.

22. The method of claim 20, wherein a computer readable medium contains instructions to perform the functions of claim 1.

23. The system of claim 19, wherein the status information indicates that the storage unit is empty.

24. The system of claim 23, further comprising transmitting the information concerning the empty storage unit to a merchant interface unit coupled to the server system.

25. The system of claim 23, further comprising transmitting the information concerning the empty storage unit to a user terminal which is coupled to the server system.

26. The device of claim 11, further comprising means in the storage unit for the user to send parcels.
